(19) United States
(12) Patent Application Publication
(10) Pub. No.: US 2004/0149923 A1
(43) Pub. Date: Aug. 5, 2004

(54) Method for obtaining a tomographic image, including apparatus

(76) Inventor: Frederik Johannes Beekman, Utrecht (NL)

Correspondence Address: ALTERA LAW GROUP, LLC, 6500 CITY WEST PARKWAY, SUITE 100, MINNEAPOLIS, MN, 55344-7704, US

(21) Appl. No.: 10/477,271

(22) PCT Filed: May 8, 2002
(86) PCT No.: PCT/NL02/00303

(30) Foreign Application Priority Data
May 11, 2001 (NL) 1018060
Dec. 27, 2001 (NL) 1019666

(51) Int. Cl. G01T 1/00

(52) U.S. Cl. 250/393; 250/363.1

(57) ABSTRACT

A method of obtaining a tomographic image by using radioactive radiation. In accordance with the invention a method is used wherein a measuring cavity is used comprising an array of pinholes, wherein an axial component of the distance between two neighboring pinholes is smaller than the distance between two neighboring pinholes which in relation to the axial direction are situated in a transversal plane, behind a pinhold Pi detection means are placed, and that means are provided to limit the chance that via pinhole Pi radiation reaches any detection means other than detection means Di. The invention also relates to a suitable apparatus.

The present invention relates to a method of obtaining a tomographic image of an animal or a part of an animal by using radioactive radiation, wherein the animal is at least partly placed into a measuring cavity, the measuring cavity possesses a wall which is provided with a plurality of pinholes, behind the pin holes (as viewed from the lumen of the measuring cavity) detection means D are placed, radioactive radiation from a radioactive isotope administered to the animal is detected in a position-dependent manner by the detection means D, and data obtained with the detection means D are used for the generation of the tomographic image.

Such an apparatus is known in the art for making tomographic images of animals, including humans, revealing a biological activity (in the case where a compound comprising the isotope to be measured is bound or metabolised) or giving an indication of which locations the isotope can reach.

There is need of a method providing a more sensitive way of measuring. This would either allow a reduction of the load of radioactive material used for measuring the animal, or it would allow a biological measurement as described above to be carried out with more precision. There is also a need for measuring at a higher resolution. These requirements of greater sensitivity and higher resolution are in part conflicting.

It is the object of the present application to provide a method that makes it possible to measure with greater sensitivity and at a higher resolution. It is a further object to provide a method by which the animal or part of the animal can be viewed from numerous angles without rotating or translating the measuring cavity in relation to the animal, or for which only a limited number of rotations or translations are needed, or wherein the distance over which rotation or translation has to take place is reduced.

To this end the method according to the preamble is characterised in that a measuring cavity is used comprising an array of pinholes, wherein an arbitrary first pinhole P₁ in a substantially axial direction in relation thereto has a nearest neighbouring pinhole P₂, and in a substantially transversal direction has a nearest neighbouring third pinhole P₃, the axial component of the distance between first and second pinholes P₁ and P₂, respectively, being smaller than the transversal component of the distance between the first and third pinholes P₁ and P₃, respectively, and in that means are provided to limit the chance that via pinhole Pi radiation reaches any detection means D other than detection means Di.

Despite deviating from the standard manner of positioning pinholes, an adequate width of the field of view (transversally) is maintained, and the animal or part of the animal is viewed from numerous angles. Because the radiation detected by a detection means D on average enter the pinholes at a less oblique angle, (i) more radiation quanta per a volume element of the measuring cavity are allowed to pass through so that the noise in the image will be reduced, and (ii) better image reconstruction becomes possible because fewer parts of the object to be measured, e.g. an animal, need to be reconstructed from measurements that are less suitable (i.e. from oblique angles). The article by Rogulski et al (IEEE Trans. Nucl. Sci. Pp 1123-1129-(1993)) describes a method of performing image reconstruction for a multiple pinhole system. For example, it is possible to reduce the chance of radiation via pinhole Pi reaching a detection means D other than the detection means Di, by adjusting the distance between a detection means Di which is located behind a pinhole Pi and the pinhole Pi. This can be done in particular by using means for reducing the distance until the desired degree of reduction is reached. The detection means Di which, viewed from the lumen, is located behind a pinhole Pi may be comprised of one single position-independent detector or, and this is preferred, of a position-dependent detector. This position-dependent detector may be a plate of photoluminescent material such as NaI, behind which photo multipliers are placed. The position-dependent detector may also be comprised of one or several (parts of) detector arrays of position-independent detection elements. More specifically, the detector arrays may be radiation-sensitive semiconductor arrays, such as detector arrays based on CdZnTe or CdTe. The detection means D may also be part of a larger detector, in which case that detector has to be a position-dependent detector. In order to reduce the chance of radiation via pinhole Pi falling on detection means D other than detection means Di, it is possible to direct the pinhole by placing it at an angle to the wall of the measuring cavity. Alternatively, the wall of the measuring cavity may be curved so that the pinhole is directed more towards the centre of the lumen. Further, the wall of the measuring cavity comprising the pinhole may have a variable thickness, such that an axially situated portion of the wall may be thicker than a transversally situated portion of the wall, which portion of the measuring cavity's wall (in part) defines the path of the beam through the pinhole. It will be obvious even to the interested layman that Pi in the present application indicates any arbitrary pinhole P, while the index i is used to indicate the relationship with a particular corresponding detection means Di, with i again being the index.

The invention also relates to an apparatus for obtaining a tomographic image of an animal or a part thereof using radioactive radiation, which apparatus comprises a measuring cavity provided with a plurality of pinholes, the measuring cavity being arranged to at least partly surround the animal where, viewed from the lumen, detection means D are provided behind the pin holes, where the detection means D are suitable for in a position-dependent manner detecting radioactive radiation and that the detection means D can be read electronically or optically.

In accordance with the invention, the wall of the measuring cavity possesses an array of pinholes, wherein an arbitrary first pinhole P₁ in a substantially axial direction in relation thereto has a nearest neighbouring pinhole P₂, and in a substantially transversal direction has a nearest neighbouring third pinhole P₃, the axial component of the distance between first and second pinholes P₁ and P₂, respectively, being smaller than the transversal component of the distance between the first and third pinholes. P₁ and P₃, respectively, and in that means are provided to limit the chance that via pinhole Pi radiation reaches any detection means D other than detection means Di.

In this way an apparatus is provided with which the above-mentioned advantages can be achieved. When speaking of “smaller”, the ratio between the transversal component of the (absolute) distance between two circumferentially neighbouring pin holes P₁ and P₃ and the axial component of the distance of two axially neighbouring pinholes P₁ and P₂, is suitably at least 1.3, preferably at least 2 and more preferably at least 5, and most preferably at least 10.

The means for reducing the chance of radiation via pinhole Pi reaching a detection means D other than the detection means Di is, for example, a device for adjusting the distance between a detection means Di located behind a pinhole Pi and the pinhole Pi. By this means the distance can be reduced until the desired degree of reduction has been reached. According to a preferred embodiment that may be used instead of, or in addition to the one mentioned above, the means comprise baffles.

Suitable positioning of the baffles, i.e. in the path along which radiation may unintentionally reach a detection means Di, may be realised very effectively and simply. To this end, the baffles are preferably directed at the lumen of the measuring cavity and more preferably the baffles are mounted on, around, or up against the surface of the detection means D. The baffles may be provided with projecting elements having a direction component parallel to the surface of the detection means.

According to a favourable embodiment it is preferred for the pinholes to be distributed over the wall of the measuring cavity such that for two peripherally neighbouring pinholes one axially neighbouring pinhole is situated halfway ±20% between the two peripheral neighbouring pinholes.

In this way it is achieved that the object to be measured can be observed under several angles without rotation or translation of the measuring cavity in relation to the animal or that it can be viewed under numerous angles with only a limited number of rotations or translations and over a short distance. This makes the reconstruction of the tomographic image simpler/more reliable. Also, a relatively simple device can be employed. In addition, it increases the possibilities of recording a successive series of images and thus of monitoring changes in time. If the pinholes are situated exactly halfway, the pattern of pinholes may also be understood to be comprised of pinholes situated at an angle of 63.4° to the axial direction of the measuring cavity. In accordance with an alternative embodiment this angle is 71.6°, 76°, or 78.7°.

To improve the imaging resolution, and/or by means of a simple translation to facilitate observation of the animal to be examined, which of course includes man, from an increased number of angles, it is in addition or alternatively also possible for at least 3 transversally spaced from one another and axially nearest neighbouring pinholes Pi to be axially staggered in relation to one another. That is to say, the pinholes are situated on a line that runs at an angle to the peripheral direction. This angle may be 20° or less, for example, 10° or less. To put it differently, the result is that the pinholes in the wall of the measuring cavity may have a spiral-like configuration.

Although it is feasible to use a scintillating crystal behind which light detectors are provided as known in the art, it is preferable to use as detection means Di placed behind a pinhole Pi a detector array, in particular a semiconductor detector array, such as a detector array based on CdZnTe or CdTe. Pixel, strip and crossed-strip detectors are also considered.

According to a favourable embodiment of the apparatus according to the invention that is simple to construct, the measuring cavity has a polygonal cross section and the wall is divided into wall segments having pinholes. Also, a polygonal construction facilitates varying the distance between the detection means and the pinholes.

In order to increase the sensitivity and to help prevent radiation unintentionally reaching the detection means, pinholes that are located nearer the ribs of the polygonal measuring cavity are at an angle to the normal of the wall segment in the direction of the centre line of the polygonal measuring cavity. The number of viewing angles is also increased, resulting in the above-mentioned advantage. The angle between the pinholes and the normal is determined by the shape of the pinhole in the surface of the wall, and the angle is the mean angle of radiation. That is to say, the pinhole is able to let radiation through from several directions from the lumen. The angle referred to above is the mean of the angles of those directions.

For the same reasons, the pinholes near one of the ribs of the polygonal measuring cavity are preferably spaced further apart than pinholes nearer to the middle between two adjacent ribs; and pinholes situated nearer the axial ends of the measuring cavity form an angle with the normal of the wall segment in the direction of the absolute centre of the measuring cavity.

In order to promote that radiation falls perpendicularly on a detection means Di, the detection means Di is preferably constructed of segments whose normal points from the centre of each segment to the pinhole Pi, or the detection means Di is curved, such that the normal at any arbitrary point of the detection means Di is oriented towards a pinhole Pi. In order to approximate the ideal spherical or cylindrical form, it is often simple to position at least two detection means Di based on semiconductors at an angle not in a plane in relation to one another. According to a preferred embodiment therefore a detection means Di situated behind a pinhole Pi comprises at least two detection means segments placed at an angle in relation to one another and out of plane, such that radiation from pinhole Pi reaching the detection means segment will on average have a more perpendicular line of incidence than if they were placed in a plane.

If the detection means Di is a photoluminescent material, the method can be carried out in a similar manner. In addition, or instead of this, the photoluminescent material may also be hollow (i.e. concave). In the latter case, the thickness of the photoluminescent material is preferably kept constant by also curving the rear side (i.e. convex). This may optionally also be cylindrical instead of spherical. In accordance with an alternative embodiment therefore, the detection means Di that is placed behind a pinhole Pi has a curved surface, such that the radiation from pinhole Pi will on average have a more perpendicular line of incidence onto each part of the detection means Di.

The invention will now be elucidated with reference to the following exemplary embodiments and the drawing, in which

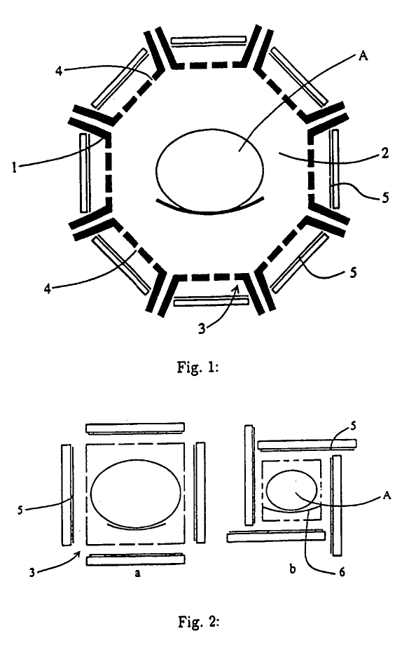

FIG. 1 shows a cross section of an apparatus according to the invention;

FIGS. 2a and b show two cross sections through an alternative apparatus according to the invention;

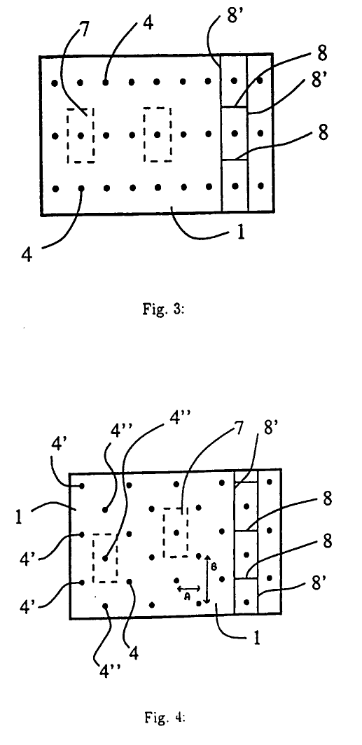

FIG. 3 shows a top view of a wall segment of an apparatus according to the invention;

FIG. 4 corresponding with FIG. 3 shows an alternative embodiment of a wall segment;

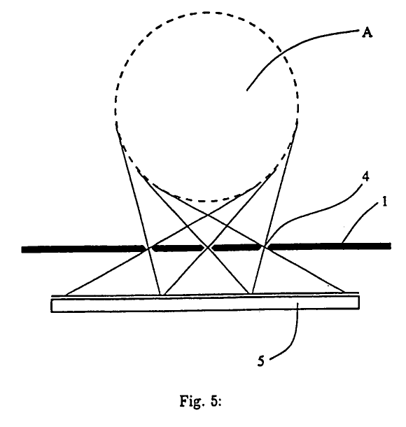

FIG. 5 shows a partial cross section with the path of the beams through three pinholes in a wall segment;

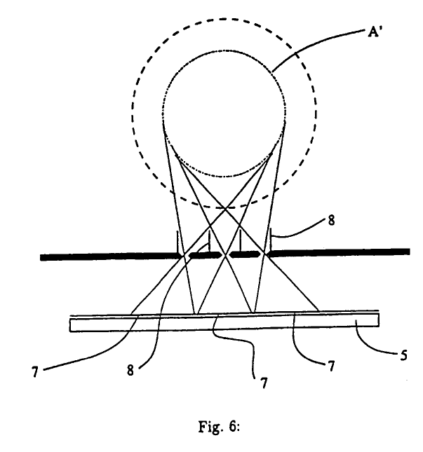

FIG. 6 substantially corresponds with FIG. 5 and shows baffles against radiation;

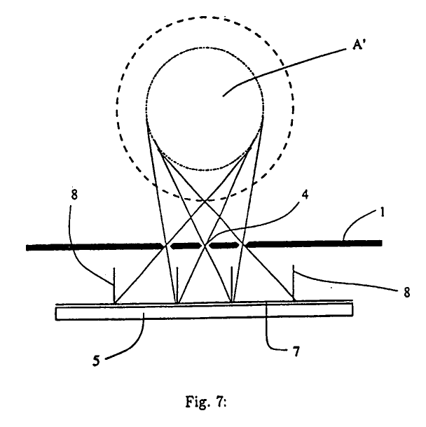

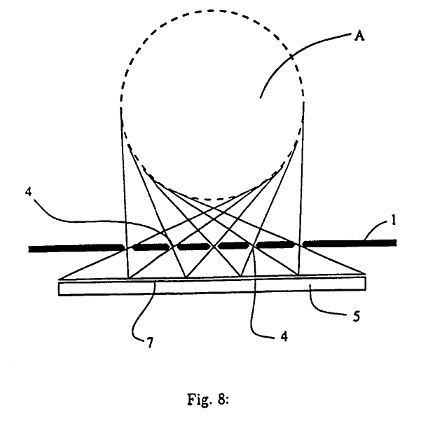

FIG. 7 substantially corresponds with FIG. 6 and shows alternatively positioned baffles against radiation;

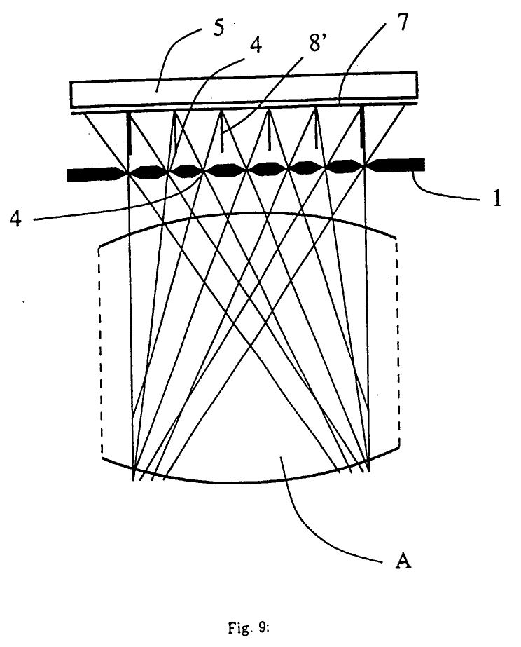

FIG. 8 substantially corresponds with FIG. 6, showing the distribution of pinholes in peripheral direction over a wall segment;

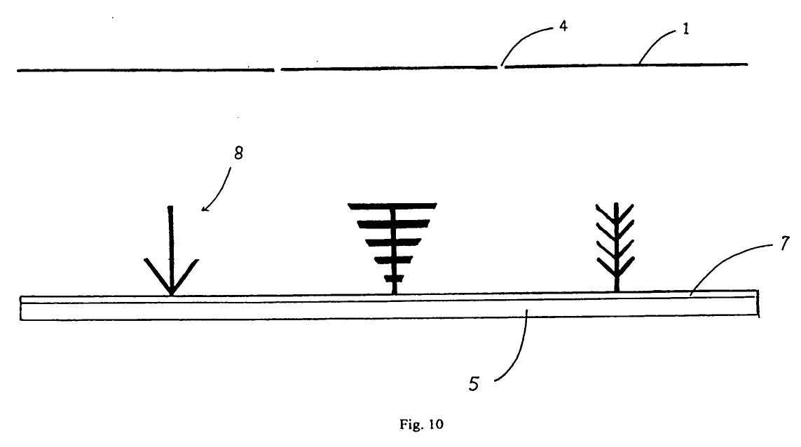

FIG. 9 shows an axial cross section of a part of the apparatus according to the invention, provided with baffles and at the distal sides of the wall segments obliquely directed pinholes.

FIG. 10 shows a position-sensitive detector provided with a few possible embodiments of baffles.

The cross-sectional view of the apparatus according to the invention shown in FIG. 1, shows a polygonal cavity 2 surrounded by wall segments 1, which wall segments 1 are provided with pinholes 4 and together they form a wall 3. Behind the pinholes position-sensitive detectors 5 are provided. As can be seen in the illustrated embodiment, an animal A or part of an animal (resting on a supporting element 6) is completely surrounded by the wall segments 1. Although this is favourable, it is not prerequisite. The animal A or a part thereof may also be surrounded over, for example, 225°. A polygonal transversal cross section has the advantage that the circular form can be mimicked to a large extent, while the manufacture of the construction elements (wall segments 1 and/or position-sensitive detectors 5) is simple. A polygon has at least three, preferably at least four and suitably six or more wall segments 1.

FIG. 2 shows an interesting variant of an apparatus according to the invention, which (in this case) has four position-sensitive detectors 5, which can be moved in relation to one another to form a surrounding surface of position- sensitive detectors 5 having a circumference that is smaller than the sum of all the widths of the position-sensitive detectors 5 (width is reckoned in the circumferential direction of the cavity 2). This provides a flexible apparatus in which both large and small animals A can be measured. The total wall 3 (defining the cavity 2) constructed from wall segments 1 is then replaced by a wall 3 having a smaller diameter and suitably positioned pinholes 4.

FIG. 3 shows a top view of a wall segment 1, in which an array of pinholes 4 is provided. In accordance with the invention, the distance between neighbouring pinholes in the axial direction (along the z-axis) is smaller than the distance between neighbouring pinholes 4 in a non-axial direction. The broken lines indicate two detector arrays 7 (situated behind the segment 1 and acting as position-sensitive detectors), each of which detect the radiation quanta of a pinhole. It goes without saying and it is preferred that such detector arrays 7 are components of a larger detector array, but it is also possible to provide one area irradiated by radiation quanta from one pinhole with more than one detector array or components thereof. Also shown are (just two) baffles 8 and 8′, which are provided on the wall segment 1 to prevent undesirable radiation from reaching detector arrays 7, as will be explained below. Each position-sensitive detector 5 comprises one or more, in practice at least 3 detector arrays 7 provided in the circumferential direction of the cavity. If a polygon with very many wall segments is chosen, it is conceivable that in axial direction each position-sensitive detector 5 comprises a series of detector arrays 7, one detector array 7 wide. To obtain a particularly good result it is ensured for each pinhole Pi, that radiation passing through the pinhole Pi will fall on each part of the detector array 7 as perpendicularly as possible. That is to say, the detector array 7 is divided into segments whose normal is oriented from the middle of a segment as much as possible towards the pinhole Pi.

FIG. 4 corresponds substantially with FIG. 3, but in a non-axial direction a series of pinholes 4′ are staggered in relation to a series of pinholes 4″. Thus, any point in the animal A can be viewed from several angles (in the transversal plane), which improves the generation of an accurate tomographic image. Broken lines indicate some underlying detector arrays 7 as position-sensitive detectors 5 (an octagon indicated by broken lines depicts a detector array 7). As explained below, with such a configuration of pinholes and the use of baffles 8′, a better reconstruction is made possible.

In accordance with the invention, FIG. 4 also shows that, for a pinhole P₁ having in substantially axial direction a nearest neighbouring pinhole P₂ and in substantially transversal direction a nearest third neighbouring pinhole P₃, the axial component A of the distance between first and second pinholes P₁ and P₂, respectively, is smaller than the transversal component B of the distance between the first and the third pinholes P₁ and P₃, respectively (please note, the orientation of the axial direction is from left to right).

FIG. 5 shows a cross section through a wall segment 1 and a position-sensitive detector 5, wherein the position-sensitive detector 5 is placed so close to the wall segment 1 that essentially no overlap exists between radiation quanta from a radioactive non-overlapping area A, such as can pass the pinholes 4. The non-overlapping radiation projections define the detector arrays.

In order to obtain a good magnification coupled with a higher image resolution, the position-sensitive detectors 5 are propitiously placed at a greater distance in relation to the wall segment 1. This is possible by using baffles 8 as. shielding means. A baffle 8 prevents radiation passing through a pinhole 4′, behind which pinhole 4′ a detector array 7′ is provided, from reaching a detector array 7 other than detector array 7′ (FIG. 6). According to the embodiment shown in FIG. 7, the baffles 8 and/or baffles 8′ are mounted on the position-sensitive detectors 5 (between adjacent detector arrays 7), providing a very effective form of radiation shield. If these baffles 8 and/or baffles 8′ are not connected to the wall segment 1, it is also possible to vary the distance from the position-sensitive detectors 5 to the wall segment 1, which provides a more versatile apparatus. The baffles 8 may also be placed up against the surface of the position-sensitive detectors 5 instead of being connected thereto.

FIG. 8 shows how, when more than three pinholes are used, the distance between the pinholes in the circumferential direction progresses. A person skilled in the art can easily determine a precise positioning. A possible manner of determining the position is one departing from an area A′ (which suitably is a round one), within which area the animal (part of the animal) that is to be imaged will be placed. At two sides of this area tangents that pass through the pinhole and determine the breadth of the radiation projection from the area A′. One single selected pinhole position then determines the positions of the other pinholes in order to obtain projections that substantially contact but do not overlap. If a flat wall section and flat position-sensitive detectors are used, the pinholes being removed further from the centre of the wall section have to be placed further apart than the pinholes that are closer to the centre of the wall section.

In order to obtain the highest possible resolution and high sensitivity, a possible option is to restrict the. measuring area A′ (as depicted in FIG. 6), i.e. to reduce its diameter. Hence, these are advantages obtained within a limited volume of the measuring cavity. By performing a translation in a transversal plane, it is possible to also measure another area of the animal with that improved resolution and sensitivity. The use of baffles 8 in accordance with the invention, allows pinholes to be positioned very closely together not only in axial direction but also in the circumferential direction so that a high sensitivity can be achieved, and in addition an excellent resolution, not only in the axial direction.

FIG. 9 shows a substantially axial cross section of an embodiment wherein the normals of pinholes 4′ form an angle with those of pinhole 4″. There are various manners of directing. According to the illustrated embodiment baffles are provided that restrict the path of the beam from particular angles through a pinhole, so that a directing effect is obtained. In other words, the baffles 8′ prevent radiation via pinhole 4′ from reaching a position-sensitive detector 5 other than detector array 7.

In this way the animal A, such as a human, or a part of the body, such as a head, can be viewed from more angles, which facilitates the reconstructability. In an embodiment not further shown here a pinhole 4′, that may be directed by means of the curve of the wall, catches radiation more effectively, which further increase the sensitivity. Especially for this application, it is advantageous for the pinholes 4 to be provided in, for example, a cylindrical body, and for a wall segment 1 to be provided with drillings (positioned at various angles) into which the cylindrical bodies are inserted.

Pinholes 4 may be unround, for example, oval or rectangular, with the longitudinal axis preferably oriented in transversal direction.

As shown in FIG. 4, axially successive series of pinholes 4 arranged substantially in transversal direction are, according to an interesting variant, staggered in relation to one another. By moving the object to be measured in the axial direction in relation to the measuring cavity, it is thus possible after the movement, to view a particular segment of the object under a different angle. In this way, a higher resolution can be attained. On the basis of the radiation energy or on the basis of a statistical distribution thereof, it is also possible to obtain more information with respect to the precise location of a radiation source in the measuring cavity.

If position-sensitive detectors 5 that measure the radiation energy are chosen as position-sensitive detectors 5, it is possible to differentiate between scattered radiation and direct radiation, and to discriminate against the former.

The application of a radioactive compound or composition to an animal and the generation of a tomographic image, which includes a three-dimensional image constructed from tomographic images obtained from measuring data, is within the general knowledge of a person skilled in the art and requires no further explanation.

The animal to be measured by means of an apparatus is generally speaking a vertebrate, more specifically a mammal. The apparatus is in particular also suitable for small mammals such as mice or rats. Measurements of parts of an animal may include examinations of brain and heart.

The baffles may be provided with radiation-absorbent and/or -reflecting elements. Some possible embodiments of these are illustrated in FIG. 10. These elements may help to prevent radiation quanta being scattered on the wall and due to scattering falling on inappropriate detection means. Even if that does happen, the fact that due to scattering the radiation quantum has lost energy makes it possible for such radiation quanta that cause noise to be filtered out by using a detection means that measures the radiation energy. One example of such a detection means is a CdZnTe detector array.

1. A method of obtaining a tomographic image of an animal or a part of an animal by using radioactive radiation, wherein the animal is at least partly placed into a measuring cavity, the measuring cavity possesses a wall which is pro- vided with a plurality of pinholes, behind the pin holes (as viewed from the lumen of the measuring cavity) detection means D are placed, radioactive radiation from a radioactive isotope administered to the animal is detected in a position- dependent manner by the detection means D, and data obtained with the detection means D are used for the generation of the tomographic image, characterized in that a measuring cavity is used comprising an array of pinholes, wherein an arbitrary first pinhole P₁ in a substantially axial direction in relation thereto has a nearest neighbouring pinhole P₂, and in a substantially transversal direction has a nearest neighbouring third pinhole P₃, the axial component of the distance between first and second pinholes P₁ and P₂, respectively, being smaller than the transversal component of the distance between the first and third pinholes P₁ and P₃, respectively, and in that means are provided to limit the chance that via pinhole Pi radiation reaches any detection means D other than detection means Di.

2. An apparatus for obtaining a tomographic image of an animal or a part thereof using radioactive radiation, which apparatus comprises a measuring cavity provided with a plurality of pinholes, the measuring cavity being arranged to at least partly surround the animal where, viewed from the lumen, detection means D are provided behind the pin holes, where the detection means D are suitable for in a position- dependent manner detecting radioactive radiation and that the detection means D can be read electronically or optically, characterized in that the wall of the measuring cavity possesses an array of pinholes, wherein the axial component of the distance between two in axial direction neighbouring pinholes is smaller than the transversal component of the distance between two neighbouring pinholes located in transversal direction with respect to the axial direction, in that a pinhole P₁ has a maximum angle of incidence αi with respect to the normal and a detection means Di located behind that pinhole, and in that means are provided to limit the chance that via pinhole Pi radiation reaches any detection means D other than detection means Di.

3. An apparatus according to claim 2, characterized in that the means comprise baffles.

4. An apparatus according to claim 3, characterized in that the baffles are oriented towards the lumen of the measuring cavity.

5. An apparatus according to claim 3 or 4, characterized in that the baffles are mounted on, around, or up against the surface of the detection means.

6. An apparatus according to one of the claims 3 to 5, characterized in that the baffles are provided with projecting elements having a direction component parallel to the surface of the detection means.

7. An apparatus according to one of the claims 2 to 6, characterized in that the pinholes are distributed over the wall of the measuring cavity such that for two peripherally neighbouring pinholes one axially neighbouring pinhole is situated halfway ±20% between the two peripheral neighbouring pinholes.

8. An apparatus according to one of the claims 2 to 7, characterized in that the pinhole is rectangular.

9. An apparatus according to one of the claims 2 to 8, characterized in that a detection means placed behind a pinhole is a detector array.

10. An apparatus according to one of the claims 2 to 9, characterized in that the measuring cavity has a polygonal cross section and the wall is divided into wall segments having pinholes.

11. An apparatus according to claim 10, characterized in that pinholes that are located nearer the ribs of the polygonal measuring cavity are at an angle to the normal of the wall segment in the direction of the centre line of the polygonal measuring cavity.

12. An apparatus according to claim 10, characterized in that pinholes near one of the ribs of the polygonal measuring cavity are spaced further apart than pinholes nearer to the middle between two adjacent ribs.

13. An apparatus according to one of the claims 2 to 11, characterized in that and pinholes situated nearer the axial ends of the measuring cavity are at an angle to the normal of the wall segment in the direction of the absolute centre of the measuring cavity.

14. An apparatus according to one of the claims 2 to 13, characterized in that at least 3 transversally spaced from one another and axially nearest neighbouring pinholes Pi are axially staggered in relation to one another.

15. An apparatus according to one of the preceding claims, characterized in that a detection means Di situated behind a pinhole Pi comprises at least two detection means segments placed at an angle in relation to one another and out of plane, such that radiation from pinhole Pi reaching the detection means segment will on average have a more perpendicular line of incidence than if they were placed in a plane.

16. An apparatus according to one of the preceding claims, characterized in that a detection means Di situated behind a pinhole Pi has a curved surface, such that the radiation from pinhole Pi will on average have a more perpendicular line of incidence onto each part of the detection means Di.
